(19) United States
(12) Patent Application Publication
(10) Pub. No.: US 2022/0019957 A1
(43) Pub. Date: Jan. 20, 2022

(54) METHOD, APPARATUS, AND COMPUTER PROGRAM OF PROVIDING REWARD-TYPE PRACTICAL TRAINING TO PRACTICAL TRAINING PARTICIPANT IN CROWDSOURCING-BASED PROJECT

(71) Applicant: CROWDWORKS INC., Seoul (KR)

(72) Inventor: Min Woo Park, Gyeonggi-do (KR)

(21) Appl. No.: 17/389,350

(22) Filed: Jul. 30, 2021

Related U.S. Application Data
(63) Continuation of application No. PCT/KR2021/007984, filed on Jul. 6, 2021.

(30) Foreign Application Priority Data
Jul. 20, 2020 (KR) 10-2020-0089731

(51) Int. Cl. G06Q 10/06; G06Q 50/20; G06Q 30/02; G06Q 10/10

(52) U.S. Cl. CPC G06Q 10/06398; G06Q 10/063118; G06Q 50/2057; G06Q 10/103; G06Q 30/0215; G06Q 30/0218; G06Q 10/06313; G06Q 10/06395

(57) ABSTRACT

A method of providing reward-type practical training to a practical training participant in a crowdsourcing-based project that enables more actual work practice by providing, as practical training, a practical training participant with tasks that are the same as those performed by a real worker, is provided.

### TECHNICAL FIELD

One or more embodiments relate to a method, an apparatus, and a computer program of providing reward-type practical training to a participant in practical training in a crowdsourcing-based project.

### BACKGROUND ART

Recently, more and more companies have been collecting and processing large amounts of data based on crowdsourcing that allows the general public to engage in some processes of company activities. In other words, a company opens one project and allows the general public, i.e., workers, to participate in the corresponding project to collect needed information via the results of work completed by the workers.

The company assigns the results of work completed by a worker to an inspector and requests the inspector to perform inspection work in order to collect more reliable information.

In detail, when one project is opened, a plurality of tasks are assigned to each of a plurality of workers. Each worker performs a plurality of assigned tasks and provides work results regarding the tasks. Each of a plurality of inspectors is assigned a plurality of inspection works for the work results, and each inspector performs the plurality of inspection works that are assigned.

Training of workers is essential to improve the quality of work that is the result of a crowdsourcing-based project. In a current tutorial for training workers, content including fixed correct answers, such as the same image, are repeatedly used for training participants. As a result, some correct answers of the tutorial are shared through a separate external community and the like. Therefore, in spite of completing worker training education, workers who are not able to perform actual tasks are gradually increasing.

Also, even for the tutorial for training workers, costs are paid in terms of worker training. Accordingly, costs for a project increase, and thus, there is a need for a method of significantly reducing costs for training workers and, at the same time, further enhancing the skills of workers to be trained.

### DESCRIPTION OF EMBODIMENTS

### Technical Problem

One or more embodiments include a method of providing reward-type practical training to a practical training participant in a crowdsourcing-based project that enables more actual work practice by providing, as practical training, a practical training participant with tasks that are the same as those performed by a real worker.

One or more embodiments include a method of providing reward-type practical training to a practical training participant in a crowdsourcing-based project that enables the performance of practical training without additional costs associated with practical training by, when more than half of practical training results that are the same as work results are input, processing the corresponding work results as inspection passes, and providing a corresponding inspection cost to a practical training worker who enters the same results.

The problems to be solved by the disclosure are not limited to the problems described above, and other problems may be present.

### Solution to Problem

According to one or more embodiments, a method of providing reward-type practical training to a practical training participant in a crowdsourcing-based project (hereinafter referred to as a project), performed by an apparatus, includes: assigning a plurality of tasks of the project to a plurality of workers and requesting the plurality of workers to perform the tasks; receiving a plurality of work results from the plurality of workers; assigning a task corresponding to any one of the plurality of work results (hereinafter referred to as a target work result) to a plurality of practical training participants and requesting the plurality of practical training participants to perform practical training; receiving a plurality of practical training results from the plurality of practical training participants; comparing the target work result by the worker with the plurality of practical training results by the plurality of practical training participants; determining whether or not to make an inspection request for the target work result, on the basis of the result of the comparing; and processing payment of rewards and evaluation scores to the plurality of practical training participants, on the basis of whether or not to make the inspection request. The determining whether or not to make the inspection request on the basis of the result of the comparing may include, when more than half of the plurality of practical training results match the target work result, processing the target work result as inspection pass without requesting inspection from an inspector, and the processing the payment of the rewards and evaluation scores to the plurality of practical training participants on the basis of whether or not to make the inspection request may include giving a first evaluation score to each of the practical training participants who input practical training results matching the target work result, and proportionally dividing and paying an inspection cost allocated to the target work result that is processed as inspection pass.

The method may further include categorizing the plurality of tasks of the project, wherein the assigning the plurality of practical training participants the task corresponding to the target work result and requesting to perform the practical training includes assigning the plurality of practical training participants the task having a category corresponding to a category of a practical training course in which the plurality of practical training participants participate and requesting the plurality of practical training participants to perform practical training.

The assigning the plurality of practical training participants the task corresponding to the target work result and requesting the plurality of practical training participants to perform the practical training may further include: receiving, from a manager of the project, a selection input for using the project as a practical training course; and receiving, from the manager of the project, a selection input for a category to be applied as the practical training course from among categories corresponding to the plurality of tasks of the project.

The method may further include granting authority of a worker capable of performing tasks to a practical training participant who accumulates, for a certain period, an evaluation score that is given for a category of a practical training course in which the plurality of practical training participants participate to have the accumulated scores satisfying a first reference evaluation score.

The assigning the plurality of practical training participants the task corresponding to the target work result and requesting the plurality of practical training participants to perform the practical training may include assigning a task corresponding to the target work result to a plurality of practical training participants as many as a greatest number of assignable practical training participants and requesting the plurality of practical training participants as many as the greatest number of assignable practical training participants to perform practical training.

The greatest number of assignable practical training participants may be determined on the basis of an inspection cost allocated to the target work result.

The method may further include: assigning the plurality of work results to a plurality of inspectors and requesting the plurality of inspectors to perform inspection; and receiving, from the plurality of inspectors, inspection passes or rejections as inspection results for the plurality of work results, wherein the determining whether or not to make the inspection request for the target work result on the basis of the result of the comparison includes, when less than half of the plurality of practical training results match the target work result, assigning the target work result to the inspector and requesting the inspector to perform inspection.

The processing the payment of the rewards and evaluation scores to the plurality of practical training participants on the basis of whether or not to make the inspection request may include giving a second evaluation score higher than the first evaluation score to a practical training participant who inputs a practical training result matching the target work result that passes inspection as the target work result passes inspection, wherein an inspection cost allocated to the target work result that passes inspection is paid to an inspector.

The method may further include excluding, from a request for the performance of the practical training, a practical training participant who accumulates, for a certain period, an evaluation score that is given for each of the plurality of practical training participants to have the accumulated evaluation scores less than a second reference evaluation score.

According to one or more embodiments, an apparatus for providing reward-type practical training to a practical training participant in a crowdsourcing-based project (hereinafter, a project) includes: a memory storing a program for providing the reward-type practical training; and a processor controlling an operation associated with the providing the reward-type practical training, wherein, when the program is execute, the processor performs: assigning a plurality of tasks of the project to a plurality of workers and requesting the plurality of workers to perform the tasks; receiving a plurality of work results from the plurality of workers; assigning a task corresponding to any one of the plurality of work results (hereinafter, a target work result) to a plurality of practical training participants and requesting the plurality of practical training participants to perform practical training; receiving a plurality of practical training results from the plurality of practical training participants; comparing the target work result by the worker with the plurality of practical training results by the plurality of practical training participants; determining whether or not to make an inspection request for the target work result, on the basis of the result of the comparing; and processing payment of rewards and evaluation scores to the plurality of practical training participants, on the basis of whether or not to make the inspection request, wherein, when performing the determining whether or not to make the inspection request on the basis of the result of the comparing, the processor, when more than half of the plurality of practical training results match the target work result, processes the target work result as inspection pass without requesting inspection from an inspector, and, when processing the payment of the rewards and evaluation scores to the plurality of practical training participants on the basis of whether or not to make the inspection request, gives a first evaluation score to each of the practical training participants who input practical training results matching the target work result, and proportionally divides and pays an inspection cost allocated to the target work result that is processed as inspection pass.

The processor may further perform categorizing the plurality of tasks of the project, wherein, when assigning the plurality of practical training participants the task corresponding to the target work result and requesting to perform the practical training, the processor may assign the plurality of practical training participants the task having a category corresponding to a category of a practical training course in which the plurality of practical training participants participate and request the plurality of practical training participants to perform practical training.

When assigning the plurality of practical training participants the task corresponding to the target work result and requesting the plurality of practical training participants to perform the practical training, the processor may receive, from a manager of the project, a selection input for using the project as a practical training course, and may receive, from the manager of the project, a selection input for a category to be applied as the practical training course from among categories corresponding to the plurality of tasks of the project.

The processor may further perform granting authority of a worker capable of performing tasks to a practical training participant who accumulates, for a certain period, an evaluation score that is given for a category of a practical training course in which the plurality of practical training participants participate to have the accumulated scores satisfying a first reference evaluation score.

When assigning the plurality of practical training participants the task corresponding to the target work result and requesting the plurality of practical training participants to perform the practical training, the processor may assign a task corresponding to the target work result to a plurality of practical training participants as many as a greatest number of assignable practical training participants and requesting the plurality of practical training participants as many as the greatest number of assignable practical training participants to perform practical training.

The greatest number of assignable practical training participants may be determined on the basis of an inspection cost allocated to the target work result.

The processor may further perform: assigning the plurality of work results to a plurality of inspectors and requesting the plurality of inspectors to perform inspection; and receiving, from the plurality of inspectors, inspection passes or rejections as inspection results for the plurality of work results, wherein when determining whether or not to make the inspection request for the target work result on the basis of the result of the comparison, the processor, when less than half of the plurality of practical training results match the target work result, may assign the target work result to the inspector and request the inspector to perform inspection.

When processing the payment of the rewards and evaluation scores to the plurality of practical training participants on the basis of whether or not to make the inspection request, the processor may give a second evaluation score higher than the first evaluation score to a practical training participant who inputs a practical training result matching the target work result that passes inspection as the target work result passes inspection, wherein the processor may pay, to an inspector, an inspection cost allocated to the target work result that passes inspection.

The processor may further perform excluding, from a request for the performance of the practical training, a practical training participant who accumulates, for a certain period, an evaluation score that is given for each of the plurality of practical training participants to have the accumulated evaluation scores less than a second reference evaluation score.

According to one or more embodiments, a computer program stored in a computer-readable recording medium to be combined with a computer to execute a method of providing reward-type practical training to a practical training participant in a crowdsourcing-based project performs: assigning a plurality of tasks of the project to a plurality of workers and requesting the plurality of workers to perform the tasks; receiving a plurality of work results from the plurality of workers; assigning a task corresponding to any one of the plurality of work results (hereinafter, a target work result) to a plurality of practical training participants and requesting the plurality of practical training participants to perform practical training; receiving a plurality of practical training results from the plurality of practical training participants; comparing the target work result by the worker with the plurality of practical training results by the plurality of practical training participants; determining whether or not to make an inspection request for the target work result, on the basis of the result of the comparing; and processing payment of rewards and evaluation scores to the plurality of practical training participants, on the basis of whether or not to make the inspection request, wherein the determining whether or not to make the inspection request on the basis of the result of the comparing includes, when more than half of the plurality of practical training results match the target work result, processing the target work result as inspection pass without requesting inspection from an inspector, and the processing the payment of the rewards and evaluation scores to the plurality of practical training participants on the basis of whether or not to make the inspection request includes giving a first evaluation score to each of the practical training participants who input practical training results matching the target work result, and proportionally dividing and paying an inspection cost allocated to the target work result that is processed as inspection pass.

Other detailed matters of the disclosure are included in the description and drawings.

### Advantageous Effects of Disclosure

According to the disclosure described above, practical training may be provided to practical training participants on the basis of work data of a worker that is in progress in real time, thereby providing more practical training than training via an existing simple tutorial that provides fixed correct answers such as the same image.

In particular, the time and the inspection fatigue of an inspector needed for inspection may be reduced without additional costs by determining whether or not to inspect a work result of a worker by using the collective intelligence of practical training participants. At the same time, a saved inspection cost may be proportionally divided and paid to the practical training participants to provide appropriate rewards for training to the practical training participants.

Effects of the disclosure are not limited to the effects mentioned above, and other unmentioned effects will be clearly understood by those skilled in the art from the following description.

### BRIEF DESCRIPTION OF DRAWINGS

FIG. 1 is a conceptual diagram of a crowdsourcing service according to an embodiment;

FIG. 2 is a flowchart illustrating a process of a crowdsourcing-based project, according to an embodiment;

FIG. 3 is a flowchart of a method of providing reward-type practical training to a practical training participant in a crowdsourcing-based project, according to an embodiment;

FIG. 4 is a view illustrating an example of categorizing a plurality of tasks of a project;

FIG. 5 is a view illustrating an embodiment in which more than half of practical training results match a target work result;

FIG. 6 is a view illustrating an embodiment in which less than half of practical training results match a target work result; and

FIG. 7 is a block diagram illustrating an apparatus (200) for providing reward-type practical training, according to an embodiment

### MODE OF DISCLOSURE

Advantages and features of the disclosure, and methods of achieving thereof will become apparent with reference to the embodiments described below in detail in conjunction with the accompanying drawings. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art, and the disclosure is merely defined by the scope of claims.

The terminology used herein is for the purpose of describing the embodiments and is not intended to limit the disclosure. As used herein, the singular forms are intended to include the plural forms as well, unless the context clearly indicates otherwise. The terms “comprises” and/or “comprising” when used in this specification do not preclude the presence or addition of one or more other elements in addition to stated elements. Like reference numerals refer to like elements throughout. As used herein, the term “and/or” includes any and all combinations of one or more of the associated listed items. Although the terms “first,” “second,” etc. may be used herein to describe various elements or components, these elements or components should not be limited by these terms. These terms are only used to distinguish one element or component from another element or component. Thus, a first element or component discussed below may be termed a second element or component without departing from the scope of example embodiments.

Unless otherwise defined, all terms (including technical and scientific terms) used herein have the same meanings as commonly understood by one of ordinary skill in the art to which example embodiments belong. Terms, such as those defined in commonly used dictionaries, will not be interpreted in an idealized or overly formal sense unless expressly so defined herein.

Hereinafter, one or more embodiments will be described in detail with reference to the accompanying drawings.

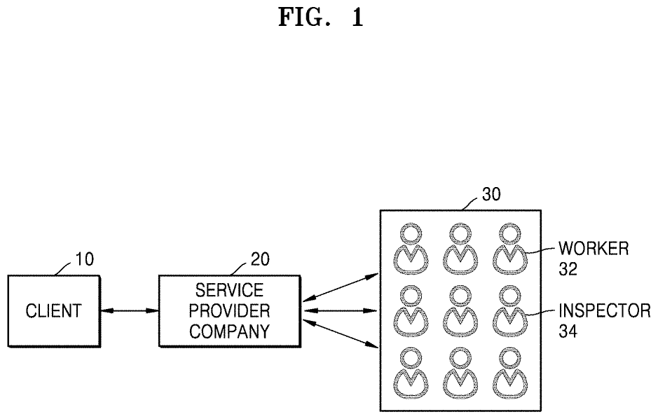

FIG. 1 is a conceptual diagram of a crowdsourcing service according to an embodiment.

Referring to FIG. 1, a crowdsourcing service is performed by constituting a client 10, a service provider company 20, and the public 30.

The client 10 refers to a company or individual that commissions a crowdsourcing-based project (hereinafter referred to as a project).

The client 10 commissions the project, for the collection of source data for the generation of artificial intelligence learning data, data annotation, or the like. Data generated via the project may be used as learning data for any machine learning such as supervised learning, unsupervised learning, or reinforcement learning. The collection of the source data refers to the collection of raw data such as the correction of recorded voice and the collection of photos. The data annotation refers to inputting associated annotation data into source data such as text, photos, and video. For example, the data annotation may include finding an entity in given text, finding a similar sentence, and the like but is not limited thereto. The type of project described above is only an embodiment, and various types of projects may be handled in the disclosure according to the design of a client.

The service provider company 20 refers to a company that provides a crowdsourcing service.

When receiving, from the client 10, a request for a product or service project, the service provider company 20 assigns work on the corresponding project to the public 30 and receives the results of work from the public 30. The service provider company 20 provides the client 10 with final outputs extracted on the basis of the results of work.

Here, the service provider company 20 provides the client 10 and the public 30 with crowdsourcing services via a crowdsourcing platform (hereinafter referred to as a platform). In other words, when the service provider company 20 receives a project request from the client 10, the service provider company 20 opens a project on the platform. When the service provider company 20 receives, from the public 30, the results of work on the opened project, the service provider company 20 may end the corresponding project on the platform, extract final outputs, and provide the extracted final outputs to the client 10.

The public 30 refers to the general public who participates in the project opened on the platform. Here, the public 30 may participate in the project opened on the platform, via an application, website, or the like provided by the service provider company 20.

The public 30 includes a worker 32 and an inspector 34.

The worker 32 determines to participate in a particular project from among a plurality of projects opened on the platform. The worker 32 performs work such as the collection of source data and data annotation, and transmits the same to the platform.

The inspector 34 determines to participate in a particular project from among the plurality of projects opened on the platform. The inspector 34 performs inspection on the results of work performed by the worker 32. The inspector 34 may perform inspection pass processing or rejection processing as the results of the inspection performance, and may input the reasons for the rejections when performing rejection processing. In the cases of inspection passes, reworks and subsequent reinspection are not needed, and thus, inspection passes mean the same as the completion of inspection.

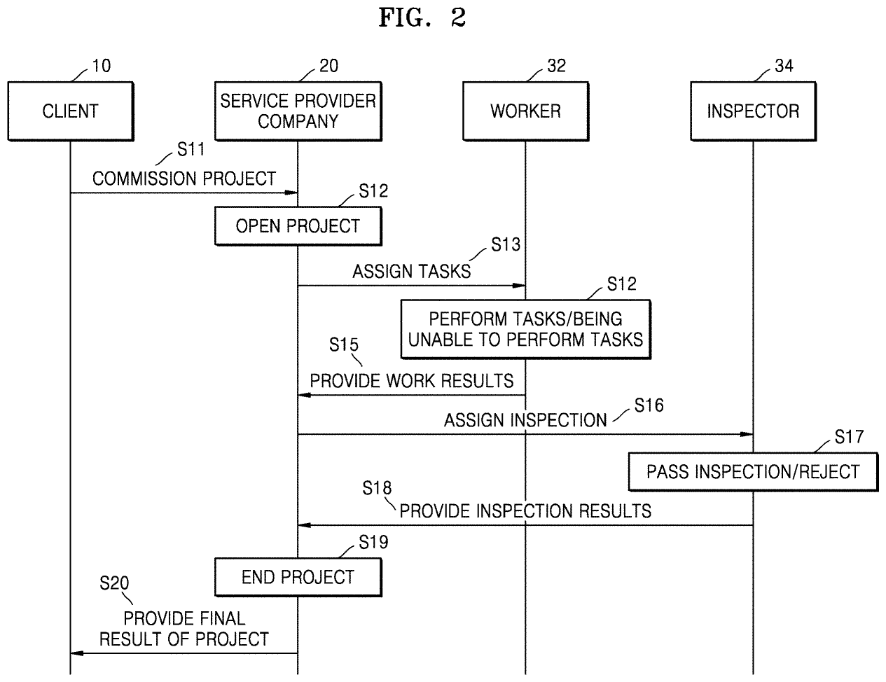

FIG. 2 is a flowchart illustrating a process of a crowdsourcing-based project according to an embodiment.

In operation S11, a client 10 commissions one or more projects to a service provider company 20.

In operation S12, the service provider company 20 opens the commissioned projects on a platform. Here, before opening a project, the service provider company 20 may determine a grade of the project by considering a level of difficulty of the corresponding project and the like. In other words, the service provider company 20 may determine to expose the corresponding project to the public 30 having a certain grade or higher, according to the level of difficulty. Accordingly, the reliability of work results of a project may be improved.

In operation S13, the service provider company 20 assigns tasks to a worker 32 having a corresponding grade or higher, according to the grade of the project, and requests to perform the tasks.

In operation S14, the worker 32 performs the allocated tasks. Here, the worker 32 may not perform a task that may not be performed for some reasons and input a reason for not being able to perform the task.

In operation S15, the service provider company 20 receives work results from the worker 32 and, in operation S16, assigns inspection work for the corresponding work results to an inspector 34 and requests inspection.

Similarly, according to an embodiment, only an appropriate project from among all projects being performed may be exposed to the inspector 34, according to grades based on levels of difficulty of the projects, or qualifications of the inspector 34.

In operation S17, the inspector 34 performs the assigned inspection. Here, the inspector 34 determines an inspection pass when a task is determined as being appropriately performed and processes the task as a rejection when the task is determined, via inspection work, as being incorrectly performed. When processing the rejection, the inspector 34 inputs a reason for the rejection of the task being determined as being incorrectly performed.

In operation S18, the service provider company 20 receives the results of inspection from the inspector 34.

When the results of inspection are inspection passes, the service provider company 20 uses the corresponding work results as valid data and, on the basis of the valid data, extracts final outputs at the end of the project.

When the results of inspection are rejection processing, the service provider company 20 may internally re-perform inspection, or may re-assign tasks to the worker 32 and request to perform rework. Reinspection by an inspector is needed upon rework.

The service provider company 20 terminates the corresponding project in operation S19 when a project period ends or sufficient valid data is secured, and, on the basis of the secured valid data, calculates the final results and provides the final results to the client 10 in operation S20.

Here, before the project ends, the service provider company 20 evaluates the performance results of the worker 32 and the inspector 34, calculates work cost and inspection cost according to the evaluation, and pays the work cost and inspection cost to the worker 32 and the inspector 34.

FIGS. 1 and 2 simply illustrate the client 10, the service provider company 20, the worker 32, and the inspector 34. However, the client 10, the service provider company 20, the worker 32, and the inspector 34 may refer to computer apparatuses or telecommunication devices such as smartphones, tablets, personal digital assistants (PDAs), laptops, desktops, and servers operated by respective participants.

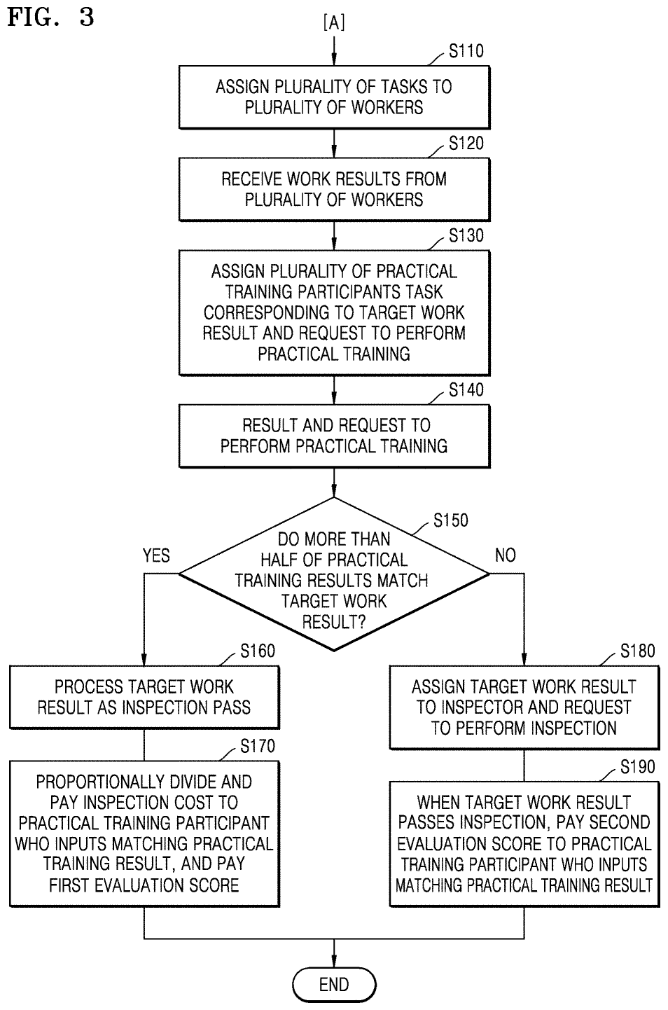

Hereinafter, a method of providing reward-type practical training to a practical training participant 33 in a crowdsourcing-based project according to an embodiment will be described with reference to FIGS. 3 through 6.

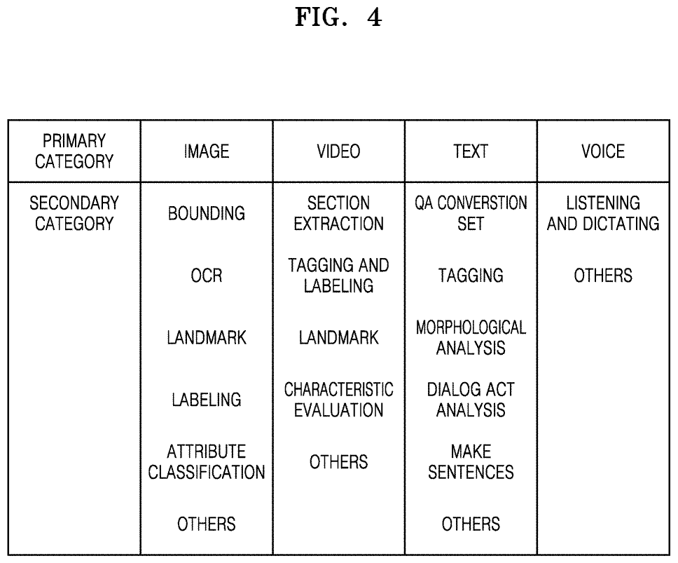

FIG. 3 is a flowchart of a method of providing reward-type practical training to a practical training participant 33 in a crowdsourcing-based project, according to an embodiment. FIG. 4 is view illustrating an example of categorizing a plurality of tasks of a project.

It may be understood that operations shown in FIG. 3 are performed by a platform server (hereinafter referred to as a server) operated by the service provider company 20, but the operations are not limited thereto.

Also, a plurality of workers 32, a plurality of practical training participants 33, or a plurality of inspectors 34 perform tasks by using certain terminal apparatuses. The terminal apparatuses of the workers 32, the practical training participants 33, or the inspectors 34 may be computer apparatuses or telecommunication devices such as smartphones, tablets, PDAs, laptops, or desktops, but are not limited thereto.

Referring to FIG. 3, a server assigns a plurality of tasks of a crowdsourcing-based project (hereinafter referred to as a project) to a plurality of workers 32 and requests to perform the tasks in operation S110, and receives a plurality of work results from the plurality of workers 32 in operation S120.

Here, one project may include a plurality of tasks, and each of the plurality of tasks may be grouped into a plurality of subtasks according to types thereof, or respective tasks may be different types of tasks or the same type of tasks but are not limited thereto.

In operation S130, the server assigns the plurality of practical training participants 33 a task corresponding to any one of the plurality of work results (hereinafter referred to as a target work result) and requests to perform practical training.

In an embodiment, tasks performed by the real worker 32 may be assigned to the practical training participant 33 to further effectively carry out worker training education for training new workers. The practical training participant 33 is assigned, for practical training, a task corresponding to the target work result submitted after the worker 32 completes the performance of tasks.

Here, all projects may not be provided for practical training of the practical training participant 33, and all tasks in a project may not be provided for practical training of the practical training participant 33.

For example, as the server receives, from a manager of a project, a selection input for using a project as a practical training course, the server may engage the practical training participant 33 in the corresponding project to conduct practical training.

As described above, when a project to be conducted as practical training is selected by a project manager, the server receives, from the project manager, a selection input for a category to be applied as a practical training course from among categories corresponding to a plurality of tasks of a project.

Therefore, according to an embodiment, a process of categorizing a plurality of tasks included in a project to be conducted as practical training may be performed.

For example, as shown in FIG. 4, tasks included in a project to be conducted as practical training may be primarily categorized into an image task, a video task, a text task, and a voice task, and each of the tasks that are primarily categorized may be secondarily categorized in detail.

In other words, the image task may be secondarily categorized into an image bounding task, an image OCR task, an image landmark task, an image labeling task, and the like. The video task may be secondarily categorized into a video section extraction task, a video tagging and labeling task, a video landmark task, and the like.

As described above, as tasks included in a project to be conducted as practical training are categorized, the server receives, from a project manager, a selection input for a category to be applied as a practical training course.

According to such a selection input, the server may assign a plurality of practical training participants 33 a task having a category corresponding to a category of a practical training course in which the plurality of practical training participants 33 participate and request to perform practical training.

Here, the selection input of the category from the project manager for the practical training course may be a selection input for a primary category or a secondary category.

For example, when the project manager makes a selection input for a primary category to conduct practical training for an image task, the server may assign a plurality of practical training participants 33 a task of the worker 32 who enters a work result corresponding to the image task that belongs to the primary category, and may request to perform practical training. Accordingly, the plurality of practical training participants 33 perform practical training for the image task. Here, secondary categories for the plurality of practical training participants 33 who are assigned the image task may be the same as or different from each other.

In contrast, when the project manager makes a selection input for a secondary category to conduct practical training for the image bounding task, the server may assign the plurality of practical training participant 33 a task of the worker 32 who inputs a work result corresponding to the image bounding task that belongs to the secondary category, and may request to perform practical training. Accordingly, the plurality of practical training participants 33 perform practical training for the image bounding task. Here, the plurality of practical training participants 33 are assigned the same image bounding task, and perform practical training.

The plurality of practical training participants 33 participant in a task corresponding to a target work result provided as practical training. Here, the number of practical training participants 33 who may participant in a task corresponding to one target work result is limited.

In other words, the number of practical training participants 33 who may participant in a task corresponding to one target work result may be at least two, but may be limited by the greatest number of assignable practical training participants 33. Here, the greatest number of assignable practical training participants 33 may be determined on the basis of an inspection cost allocated to a target work result.

For example, when a worker A submits a work result for the image bounding task, only six practical training participants may participate in the image bounding task corresponding to a target work result of the worker A, and the same number of practical training participants may also be applied to tasks for target work results of a worker B and a worker C.

Therefore, as described below, an inspection cost is set for each work result of the worker 32. In an embodiment, when practical training results that are input by more than half of a plurality of practical training participants 33 match a work result of the worker 32, an inspection request is omitted for the work result of the corresponding worker 32, and an allocated inspection cost is proportionally divided and provided to more than half of practical training participants. Here, the number of practical training participants 33 who may participate per one task is limited to provide a reasonable reward cost to the practical training participants 33.

Referring to FIG. 3 again, when the server receives a plurality of practical training results from the plurality of practical training participants 33 in operation S140, in operation S150, the server compares the target work result by the worker 32 with the plurality of practical training results by the plurality of practical training participants 33.

Also, the server determines whether or not to make an inspection request for the target work result, on the basis of the result of the comparison, and processes payment of rewards and evaluation scores to the plurality of practical training participants 33, on the basis of whether or not to make the inspection request.

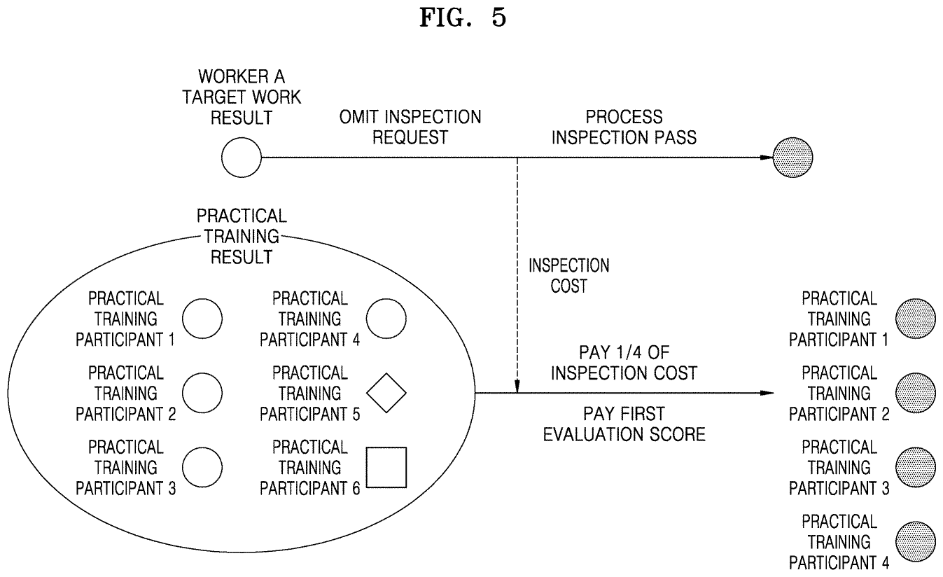

FIG. 5 is a view illustrating an embodiment in which more than half of practical training results match a target work result.

In an embodiment, when more than half of a plurality of practical training results match a target work result, in operation S160, the server processes the target work result as an inspection pass without requesting inspection from the inspector 34 for the target work result.

In operation S170, the server pays a first evaluation score to each of more than half of practical training participants 33 who inputs practical training results matching the target work result, and proportionally divides and pays, to more than half of practical training participants 33, an inspection cost allocated to the target work result that is processed as the inspection pass.

For example, as shown in FIG. 5, when a task for a target work result of a worker A for image bounding is assigned to six practical training participants, and, when practical training results of four of the six practical training participants for the image bounding match the target work result, the target work result of the worker A is processed as an inspection pass without requesting inspection from the inspector 34.

Also, the four practical training participants are each assigned two scores as a first evaluation score, and an inspection cost of 4,000 won allocated for the target work result is divided so that the four practical training participants are each paid 1,000 won.

In the embodiment described above, practical training may be provided to the practical training participant 33 on the basis of work data of the worker 32 that is in progress in real time. Therefore, more practical training than training via a simple tutorial may be provided.

In particular, practical training may be conducted without additional costs, and at the same time, the time and the inspection fatigue of the inspector 34 required for inspection may be reduced, by using the collective intelligence of the practical training participants 33.

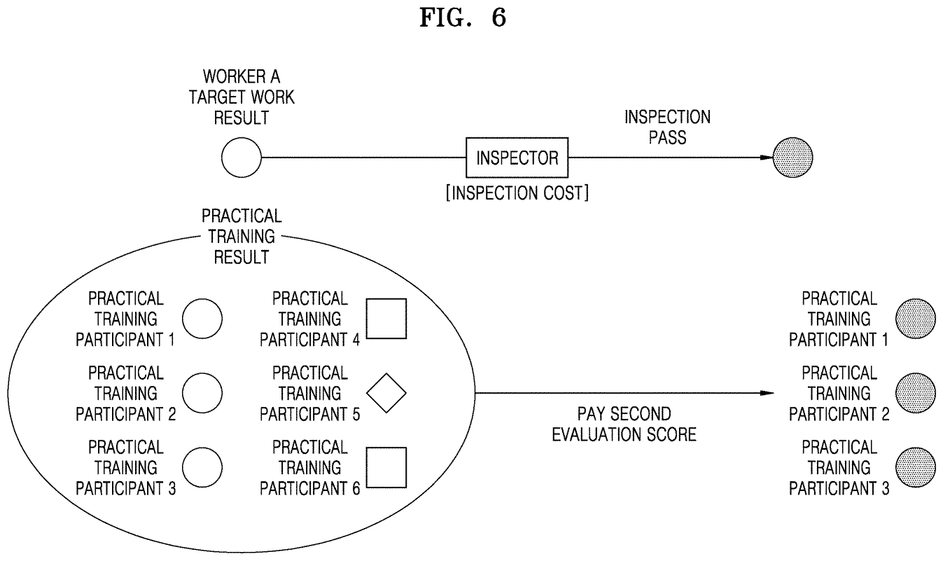

FIG. 6 is a view illustrating an embodiment in which less than half of practical training results match a target work result.

A server assigns a plurality of inspectors 34 a plurality of work results that are not provided as a target work result, or do not correspond to a training target category and thus are not scheduled to be provided as a target work result, requests to perform inspection, and receives, from the plurality of inspectors 34, inspection passes or rejections as inspection results for the plurality of work results.

Here, in an embodiment, when a plurality of practical training results matching a target work result is less than a majority, unlike in the embodiment of FIG. 5, the inspector 34 is also assigned the target work result and requested to perform inspection in operation S180.

Also, in operation S190, as the target work result passes inspection by the inspector 34, the server pays a second evaluation score higher than the first evaluation score to less than half of practical training participants 33 who inputs practical training results matching the target work result that passes inspection.

For example, as shown in FIG. 6, when six practical training participants are assigned a task for a target work result of a worker A for image bounding, and only practical training results of three of the six practical training participants for the image bounding match the target work result, the target work result of the worker A is assigned to an inspector and requested for inspection to perform an inspection process.

When the target work result of the worker A is finally completely inspected such as immediately passing inspection or being rejected and then passing inspection, the second evaluation score of 4 scores that is higher than the first evaluation score is assigned to each of three practical training participants who inputs practical training results that are the same as the target work result of the worker A for the image bounding.

Here, the target work result of the worker A is inspected by an inspector. Therefore, unlike in the embodiment of FIG. 5, an inspection cost is paid to the inspector, rather than to the three practical training participants.

The three practical training participants input the same correct answers, but are not equally paid the inspection cost. Therefore, for equity with the other practical training participants who are equally paid the inspection cost, the second evaluation score that is higher than the first evaluation score may be assigned to the corresponding practical training participants.

Practical training results of the practical training participants 33 may be provided to the inspector 34, and the inspector 34 may perform inspection for a target work result with reference to the practical training results of the practical training participants 33.

As described above, as practical training for the practical training participant 33 progresses, an evaluation score for a category of a practical training course in which a plurality of practical training participants 33 participate is accumulatively paid for a certain period. In other words, each of the practical training participants 33 continues to receive the first evaluation score or the second evaluation score as practical training progresses. Here, the certain period may be a period taken until a plurality of tasks that may be used as a practical training course of a project are all assigned to the practical training participants 33, a training period set by a project manager, or the like.

The server may grant authority of the worker 32 capable of performing tasks to a practical training participant 33 having accumulated evaluation scores satisfying a first reference evaluation score from among a plurality of practical training participants 33.

For example, a practical training participant 33 who achieves a first reference evaluation score of 100 by accumulating evaluation scores may be granted authority to participate as the worker 32 in a project that is currently in progress or to be conducted in the future.

In contrast, the server stops a currently participating practical training by excluding, from a request to perform practical training for a task, a practical training participant 33 having accumulated evaluation scores less than a second reference evaluation score from among a plurality of practical training participants 33.

For example, practical training that is currently in progress is stopped for a practical training participant 33 who, as evaluation scores are accumulated, corresponds to a second reference evaluation score of 20 or corresponds to the bottom 20% compared to the other practical training participants 33.

Also, basic training via audiovisual materials or tutorial materials may be preformed again for the corresponding practical training participant 33, and then may be completed again, thereby allowing the corresponding practical training participant 33 to re-participate in the practical training.

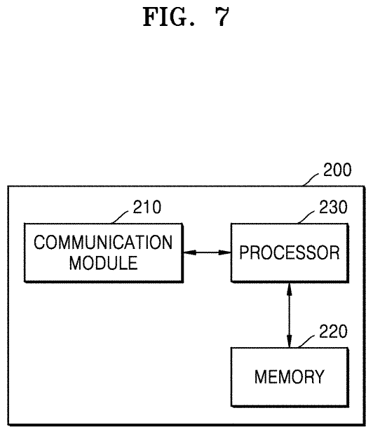

The above description, according to an embodiment, operations S110 through S190 may be further divided into additional operations or may be combined into sub-operations. Also, some operations may be omitted when needed or the order between operations may also be changed. In addition, even though the following description of FIG. 7 is omitted, the description may also be applied to the method of providing reward-type practical training to a practical training participant 33 in a crowdsourcing-based project described with reference to FIGS. 1 through 6.

Hereinafter, an apparatus 200 (hereafter referred to as a reward-type practical training provision apparatus) for providing reward-type practical training to a practical training participant 33 in a crowdsourcing-based project according to an embodiment will be described.

FIG. 7 is a block diagram illustrating a reward-type practical training provision apparatus 200 according to an embodiment.

Referring to FIG. 7, the reward-type practical training provision apparatus 200 according to an embodiment includes a communication module 210, a memory 220, and a processor 230.

The communication module 210 transmits crowdsourcing-based tasks of one project to a plurality of workers 32 to request to perform the tasks, and receives work results from the plurality of workers 32. Also, a plurality of practical training participants 33 are assigned a task corresponding to a target work result that is any one of a plurality of work results and requested to perform practical training, and a plurality of practical training results are received from the plurality of practical training participants 33.

The memory 220 stores a program that compares a target work result by the worker 32 with a plurality of practical training results by a plurality of practical training participants 33, determines whether or not to make an inspection request for the target work result, on the basis of the result of the comparison, and processes payment of rewards and evaluation scores to the plurality of practical training participants 33, on the basis of whether or not to make the inspection request.

The processor 230 executes the program stored in the memory 220. As the processor 230 executes the program stored in the memory 220, when more than half of the plurality of practical training results match the target work result, the processor 230 processes the target work result as an inspection pass without requesting inspection from the inspector 34. Also, the processor 230 pays a first evaluation score to each of the practical training participants 33 who inputs practical training results matching the target work result, and proportionally divides an inspection cost allocated to the target work result that is processed as the inspection pass, and pays the proportionally divided inspection costs to the corresponding practical training participants 33, respectively.

In contrast, when less than half of the plurality of practical training results match the target work result, the processor 230 assigns the target work result to the inspector 34 and requests to perform inspection, and pays a second evaluation score higher than the first evaluation score to a practical training participant 33 who inputs a practical training result matching the target work result that passes inspection as the target work result passes inspection.

The reward-type practical training provision apparatus 200 described with reference to FIG. 7 may be provided as a component of the server described above.

A method of providing reward-type practical training to a practical training participant 33 in a crowdsourcing-based project, according to an embodiment, as described above may be implemented as a program (or an application) to be combined with a computer that is hardware and to be executed, and then may be stored in a medium.

In order for the computer to read the program and execute the methods implemented as the program, the above-described program may include a code coded in a computer language such as C, C++, JAVA, Ruby, and machine language that may be read by a processor (CPU) of the computer via a device interface of the computer. Such code may include functional code related to a function that defines functions needed for executing the above methods, and the like, and may include execution procedure-related control code needed for the processor of the computer to execute the functions according to a preset procedure. Also, such code may further include memory reference-related code indicating a location (address) in an internal or external memory of the computer at which additional information or media needed for the processor of the computer to execute the functions may be referred to. Also, when the processor of the computer needs to communicate with any other computer or server at a remote location to execute the functions, the code may further include communication-related code indicating a method of communicating with any other computer or server at a remote location by using a communication module of the computer, and information or media that is transmitted and/or received during communication, and the like.

The storage medium refers to a medium that stores data semi-permanently and may be read by a device, rather than a medium that stores data for a short moment, such as a register, a cache, or a memory. In detail, examples of the storage medium include ROM, RAM, CD-ROM, magnetic tape, floppy disks, optical data storage devices, and the like but are not limited thereto. In other words, the program may be stored in various types of recording media on various servers that may be accessed by the computer or in various types of recording media on the computer of a user. Also, the media may be distributed over network-coupled computer systems so that computer-readable code is stored in a distributed fashion.

The foregoing description of the disclosure is for purposes of illustration, and those of ordinary skill in the art to which the disclosure pertains may understand that it may be easily modified into other specific forms without changing the technical spirit or essential features of the disclosure. Therefore, it may be understood that the embodiments described above are illustrative in all respects and not restrictive. For example, each element described as a single type may be implemented in a distributed manner, and likewise, elements described as being distributed may also be implemented in a combined form.

The scope of the disclosure is defined by the following claims, rather than by the above description, and all changes or modifications derived from the concept and scope of the claims and equivalents thereof may be construed as being included in the scope of the disclosure.

What is claimed is:

1. A method of providing reward-type practical training to a practical training participant in a crowdsourcing-based project (hereinafter, a project), performed by an apparatus, the method comprising:
assigning a plurality of tasks of the project to a plurality of workers and requesting the plurality of workers to perform the tasks;
receiving a plurality of work results from the plurality of workers;
assigning a task corresponding to any one of the plurality of work results (hereinafter, a target work result) to a plurality of practical training participants and requesting the plurality of practical training participants to perform practical training;
receiving a plurality of practical training results from the plurality of practical training participants;
comparing the target work result by the worker with the plurality of practical training results by the plurality of practical training participants;
determining whether or not to make an inspection request for the target work result, on the basis of the result of the comparing;
processing payment of rewards and evaluation scores to the plurality of practical training participants, on the basis of whether or not to make the inspection request;
assigning the plurality of work results to a plurality of inspectors and requesting the plurality of inspectors to perform inspection;
receiving, from the plurality of inspectors, inspection passes or rejections as inspection results for the plurality of work results; and
excluding, from a request for the performance of the practical training, a practical training participant who accumulates, for a certain period, an evaluation score that is given for each of the plurality of practical training participants to have the accumulated evaluation scores less than a second reference evaluation score,
wherein the assigning the plurality of practical training participants the task corresponding to the target work result and requesting the plurality of practical training participants to perform the practical training includes,
assigning a task corresponding to the target work result to a plurality of practical training participants as many as a greatest number of assignable practical training participants and requesting the plurality of practical training participants as many as the greatest number of assignable practical training participants to perform practical training,
wherein the greatest number of assignable practical training participants is determined on the basis of an inspection cost allocated to the target work result, wherein the determining whether or not to make the inspection request on the basis of the result of the comparing includes,
when more than half of the plurality of practical training results match the target work result, processing the target work result as inspection pass without requesting inspection from an inspector, and
the processing the payment of the rewards and evaluation scores to the plurality of practical training participants on the basis of whether or not to make the inspection request includes
giving a first evaluation score to each of the practical training participants who input practical training results matching the target work result, and proportionally dividing and paying an inspection cost allocated to the target work result that is processed as inspection pass,
wherein the determining whether or not to make the inspection request for the target work result on the basis of the result of the comparison includes,
when less than half of the plurality of practical training results match the target work result, assigning the target work result to the inspector and requesting the inspector to perform inspection,
wherein the determining whether or not to make the inspection request for the target work result on the basis of the result of the comparison includes,
when less than half of the plurality of practical training results match the target work result, assigning the target work result to the inspector and requesting the inspector to perform inspection,
wherein the processing the payment of the rewards and evaluation scores to the plurality of practical training participants on the basis of whether or not to make the inspection request includes giving a second evaluation score higher than the first evaluation score to a practical training participant who inputs a practical training result matching the target work result that passes inspection as the target work result passes inspection, wherein an inspection cost allocated to the target work result that passes inspection is paid to an inspector.

2. The method of claim 1, further comprising:
categorizing the plurality of tasks of the project, wherein
the assigning the plurality of practical training participants the task corresponding to the target work result and requesting to perform the practical training includes
assigning the plurality of practical training participants the task having a category corresponding to a category of a practical training course in which the plurality of practical training participants participate and requesting the plurality of practical training participants to perform practical training.

3. The method of claim 2, wherein
the assigning the plurality of practical training participants the task corresponding to the target work result and requesting the plurality of practical training participants to perform the practical training further includes:
receiving, from a manager of the project, a selection input for using the project as a practical training course; and
receiving, from the manager of the project, a selection input for a category to be applied as the practical training course from among categories corresponding to the plurality of tasks of the project.

4. The method of claim 2, further comprising:
granting authority of a worker capable of performing tasks to a practical training participant who accumulates, for a certain period, an evaluation score that is given for a category of a practical training course in which the plurality of practical training participants participate to have the accumulated scores satisfying a first reference evaluation score.

5. A non-transitory computer program stored in a computer-readable recording medium to be combined with a computer to execute a method of claim 1 of of providing reward-type practical training to a practical training participant in a crowdsourcing-based project.
